(19) United States
(12) Patent Application Publication
(10) Pub. No.: US 2007/0295555 A1
(43) Pub. Date: Dec. 27, 2007

(54) Hoisting harness assembly

(75) Inventor: Charles R. O'Rourke, Lexington Park, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: The United States of America as represented by the Secretary of the Navy

(21) Appl. No.: 11/482,303

(22) Filed: Jun. 26, 2006

(51) Int. Cl. A62B 35/00

(52) U.S. Cl. 182/3

(57) ABSTRACT

A hoisting harness assembly including a saddle strap, two leg straps, and two shoulder straps. The saddle strap has two saddle strap ends. Each leg strap has a first leg strap end and a second leg strap end, each first leg strap end is attached to the saddle strap such that a seat area is formed by the saddle strap and the two leg straps. Each shoulder strap has a first shoulder strap end and a second shoulder strap end, one of the first shoulder strap ends is attachable to one of the two saddle strap ends. The other first shoulder strap end is attachable to the other saddle strap end, and each second shoulder strap end is attachable to a corresponding second leg strap end.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a harness assembly. More specifically, but without limitation, the present invention relates to a hoisting harness assembly.

In many military situations (typically in rescue situations) a person must be hoisted up into a rescue aircraft, such as a helicopter. The current hoisting harness used by the United States Navy, Marine Corps and Army has several deficiencies. When a person is hoisted, the person's head is placed at or slightly below the helicopter's floorboard. This makes it difficult for the hoist operator to effect retrieval of the person. In addition, the currently used harness (CMU-33A/P22P-18(V), AIRSAVE Survival Vest Hoisting Harness) suspends the person from the right shoulder only, which creates difficulty for a rescue swimmer to control the survivor while being hoisted. Furthermore, the currently used harness is unsafe for a survivor with potential back or neck injuries. It is also uncomfortable to the wearer, placing undue strain and discomfort to the thorax, neck and legs.

For the foregoing reasons, there is a need for a hoisting harness that is safer, more comfortable and provides a more risk free and secure hoist.

### SUMMARY

The present invention is directed to a hoisting harness assembly that meets the needs enumerated above and below.

The present invention is directed to a hoisting harness assembly that includes a saddle strap, two leg straps, and two shoulder straps. The saddle strap has two saddle strap ends. Each leg strap has a first leg strap end and a second leg strap end, each first leg strap end is attached to the saddle strap such that a seat area is formed by the saddle strap and the two leg straps. Each shoulder strap has a first shoulder strap end and a second shoulder strap end, one of the first shoulder strap ends is attachable or removably attached to one of the two saddle strap ends. The other first shoulder strap end is attachable or removably attached to the other saddle strap end, and each second shoulder strap end is attachable or removably attached to a corresponding second leg strap end.

The present invention is directed to a hoisting harness assembly that can be used either as a stand-alone garment or in conjunction with a survival vest.

It is a feature of the invention to provide a hoisting harness assembly that includes a saddle assembly that safely encapsulates and stabilizes a user's lower pelvis area during hoisting.

It is also a feature of the present invention to provide a hoisting harness assembly that includes quick connect/disconnect hardware features that provide a means to quickly divest the leg straps with a single one-handed motion, if so desired.

It is also a feature of the invention to provide a hoisting harness assembly that has a safe and comfortable fit of both the vertical and circumferential measurements of personnel from about the 3% female to about the 98% male sizing range.

It is a further feature of the invention to provide a hoisting harness assembly that reduces adverse loading on the spine, ribcage, and groin area of the individual being hoisted, while retaining the individual in a seated orientation.

It is also a feature of the present invention to provide a hoisting harness assembly that integrates into any current survival vest without causing interference with common flight clothing or aviation survival equipment currently in use.

### DRAWINGS

These and other features, aspects and advantages of the present invention will become better understood with reference to the following description and appended claims, and accompanying drawings wherein:

FIG. 1 is a perspective view of an embodiment of the hoisting harness assembly;

FIG. 2 is a rear view of an embodiment of the hoisting harness assembly; and, FIG. 3 is an exploded view of an embodiment of the receiver and the key assembly.

### DESCRIPTION

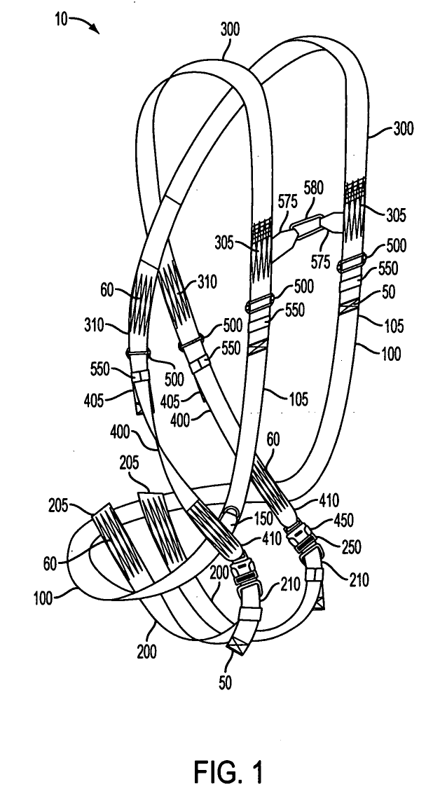

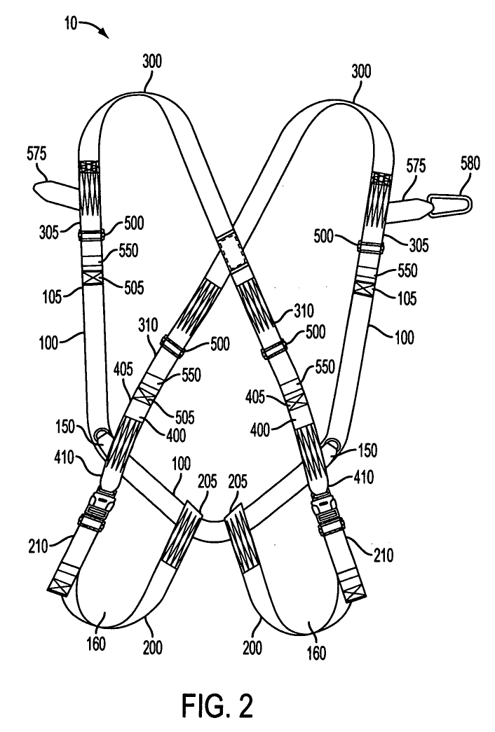

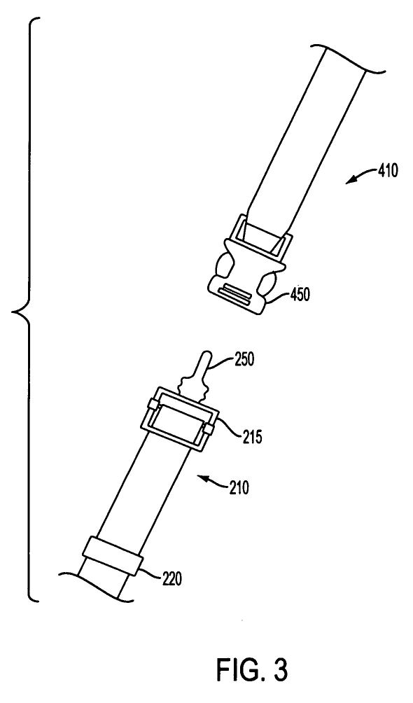

The preferred embodiment of the present invention is illustrated by way of example below and in FIGS. 1, 2 and 3. As shown in FIGS. 1 and 2, the hoisting harness 10 includes a saddle strap 100, two leg straps 200, two shoulder straps 300 and two receiver straps 400. The saddle strap 100 has two saddle strap ends 105. Each leg strap 200 has a first leg strap end 205 and a second leg strap end 210. Each first leg strap end 205 is attached to the saddle strap 100 such that a seat area is formed by the saddle strap 100 and the two leg straps 200. Each shoulder strap 300 has a first shoulder strap end 305 and a second shoulder strap end 310. Each receiver strap 400 has a first receiver strap end 405 and a second receiver strap end 410. One of the first shoulder strap ends 305 is adjustably attached to one of the saddle strap ends 105, while the other first shoulder strap end 305 is adjustably attached to the other saddle strap end 105. Each second shoulder strap end 310 is adjustably attached to a corresponding first receiver strap end 405, and each second receiver strap end 410 is attachable or removably attached to a corresponding second leg strap end 210.

In the discussion of the present invention, the invention will be discussed in a military rescue environment; however, this invention can be utilized for any type of need that requires use of a hoisting harness assembly.

As shown in FIGS. 1 and 2, the hoisting harness 10 may include strap assembly attachments 150. The strap assembly attachments 150 attach the saddle strap 100 to the receiver straps 400 (but not at or about the first receiver strap ends 405 or the second receiver strap ends 410) such that loops 160 are created so that the legs of a user may slip into the loops 160. In the preferred embodiment, there are two strap assembly attachments 150 that are disposed at the proximate area of a user's hips or pelvic region. In the preferred embodiment, the strap assembly attachment 150 is a D-ring type attaching mechanism or attacher. The strap assembly attachment 150 may be utilized to refrain the life preserver attached to the survival vest.

At each attachment area of the saddle strap end 105 and the first shoulder strap end 305 there is an adjuster 500 and a keeper assembly 550. Each saddle strap end 105 and corresponding first shoulder strap end 305 communicate with an adjuster 500 so that the saddle strap 100 and the shoulder strap 300 can be adjusted to fit different size users. The adjusters 500 may be any type of adjuster practicable, such as, but without limitation, a friction adapter that can be adjusted to fit the vertical size of a user and allow the size to be adjusted. The keeper assembly 550 is an assembly that holds the straps so that any excess strap will be held in place. At each attachment area of the second shoulder strap ends 310 and the first receiver strap ends 405 there may also be an adjuster 500 and a keeper assembly 550 that operates and functions in a similar manner.

The hoisting harness assembly 10 may include quick connect/disconnect hardware. The quick connect/disconnect hardware may be any type of hardware practicable, such as, but without limitation, a bayonet (key) and receiving hardware system. In the preferred embodiment, as seen in FIGS. 1, 2 and 3 there is a receiver 450 at each second receiver strap end 410. The receiver 450 may be sewn into the second receiver strap end 410 or attached by any method practicable. The receiver 450 is adapted to accept a key 250. Each second leg strap end 210 has a key 250 attached to it. The receiver 450 and key 250 operate as a quick connect/disconnect that attaches each second leg strap end 210 to its corresponding second receiver strap end 410. The hardware may also include a leg strap adjuster 215 for adjusting sizing of the leg straps 200 and a leg strap keeper assembly 220 to hold any excess strap in place.

In the preferred embodiment, attached to each shoulder strap 300 there is a strap assembly lift 575. The strap assembly lifts 575 may be located at or above the first shoulder strap end 305 so that the strap assembly lifts 575 are on the front shoulder/upper chest area of a user. Both strap assembly lifts 575 are corresponding such that a snap link 580 may be attached to both strap assembly lifts 575. In a typical rescue operation, the hoist is attached to the snap link 580, and the person is hoisted in a sitting position to the rescue platform via a hoist attached to the snap link 580.

In the preferred embodiment, the straps 100, 200, 300, and 400 are manufactured from nylon; however, they may be manufactured from any type of material practicable. The straps 100, 200, 300, and 400 may include stitching on them. The stitching patterns may be cross boxstitch 50, double W 60, or any other type of stitching practicable. In the preferred embodiment, the receiver straps 400 have “double W” stitching 60 at or near their second receiver strap ends 410. At the saddle strap ends 105, the first receiver strap ends 405 and the second leg strap ends 210 there may be fold overs 505, which may have a cross box stitching 50. In another embodiment of the invention, every end of every strap may include a fold over 505, or any other type of combination, thereof.

In operation, prior to a mission or training operation, a crewmember or user dons a survival vest with the hoisting harness assembly 10 attached to the survival vest. The hoisting harness assembly 10 may also be worn alone or in conjunction with a survival vest or similar type equipment. The loops 160 are formed around the user's legs, snapped into place with the attaching hardware. Slack is adjusted out through the leg strap adjuster 215 located on the key 250. Part of the saddle strap 100 and the first leg strap ends 205 are disposed near the user's buttocks. The two leg straps 200 extend from the saddle strap 100 around the user's buttocks toward and around the user's inner thighs. The saddle strap 100 extends on both sides of the user from the buttocks past and around the pelvic region, past the user's abdominal area and up by the user's chest region. The shoulder straps 300 extend from the saddle strap ends 105 to around the shoulders, the shoulder straps 300 then criss cross forming an X on the user's back. The receiver straps 400 extend from the second shoulder strap end 310 down to the pelvic region, back around to the front of the user. The leg straps 200 are connected via a quick connect/disconnect to the second receiver strap end 405. The straps are adjusted and the hoisting harness assembly 10 is tightened around the user via the adjusters 500. Any excess strap is held down and connected via corresponding keeper assemblies 550, 220. The excess strap may also be tacked in placed or attached via any other method practicable.

When introducing elements of the present invention or the preferred embodiment(s) thereof, the articles “a”, “an”, “the” and “said” are intended to mean there are one or more of the elements. The terms “comprising,” “including,” and “having” are intended to be inclusive and mean that there may be additional elements other than the listed elements.

Although the present invention has been described in considerable detail with reference to a certain preferred embodiment thereof, other embodiments are possible. Therefore, the spirit and scope of the appended claims should not be limited to the description of the preferred embodiment(s) contained herein.

What is claimed is:

1. A hoisting harness assembly, comprising:
a saddle strap, the saddle strap having two saddle strap ends;
two leg straps, each leg strap having a first leg strap end and a second leg strap end, each first leg strap end attached to the saddle strap such that a seat area is formed by the saddle strap and the two leg straps; and,
two shoulder straps, each shoulder strap having a first shoulder strap end and a second shoulder strap end, one of the first shoulder strap ends attachable to one of the two saddle strap ends, the other first shoulder strap end attachable to the other saddle strap end, each second shoulder strap end attachable to a corresponding second leg strap end.

2. The hoisting harness assembly of claim 1, wherein the two shoulder straps criss cross on a user's back.

3. A hoisting harness assembly, comprising:
a saddle strap, the saddle strap having two saddle strap ends;
two leg straps, each leg strap having a first leg strap end and a second leg strap end, each first leg strap end attached to the saddle strap such that a seat area is formed by the saddle strap and the two leg straps;
two shoulder straps, each shoulder strap having a first shoulder strap end and a second shoulder strap end; and,
two receiver straps, each receiver strap having a first receiver strap end and a second receiver strap end, one of the first shoulder strap ends adjustably attached to one of the two saddle strap ends, the other first shoulder strap end adjustably attached to the other saddle strap end, each second shoulder strap end adjustably attached to a corresponding first receiver strap end, each second receiver strap end attachable to a corresponding second leg strap end.

4. The hoisting harness assembly of claim 3, wherein the two shoulder straps criss cross on a user's back.

5. The hoisting harness assembly of claim 4, wherein each second leg strap end is attachable to a corresponding second receiver strap end via a quick connect/disconnect assembly.

6. The hoisting harness assembly of claim 4, wherein each second receiver strap end includes a receiver and each second leg strap end includes a key, the key corresponding to the receiver such that the second leg strap ends and the second receiver strap ends may be quickly connected or disconnected.

7. The hoisting harness assembly of claim 6, wherein the hoisting harness assembly further includes two strap assembly attachments, each strap assembly attachment attaches a receiver strap to the saddle strap.

8. The hoisting harness assembly of claim 7, wherein the hoisting harness assembly further includes adjusters and keeper assemblies, the adjuster for adjusting to fit the hoisting harness assembly around a user, the keeper assembly holding any excess strap in place.

9. The hoisting harness assembly of claim 8, wherein the hoisting harness assembly further includes two strap assembly lifts, each strap assembly lift attached to a corresponding shoulder strap, the strap assembly lifts adapted to connect to a snap link which is connectable to a hoist.
